(19) United States
(12) Patent Application Publication
(10) Pub. No.: US 2009/0214968 A1
(43) Pub. Date: Aug. 27, 2009

(54) MIXTURE OF BISAMINE COMPOUNDS, ELECTROPHOTOGRAPHIC PHOTORECEPTOR, METHOD FOR FORMING IMAGE, AND IMAGE FORMING APPARATUS

(75) Inventors: Shinichi Hamaguchi, Hino-shi (JP); Toyoko Shibata, Zama-shi (JP); Tomoko Sakimura, Hino-shi (JP)

Correspondence Address: BUCHANAN, INGERSOLL & ROONEY PC, POST OFFICE BOX 1404, ALEXANDRIA, VA, 22313-1404, US

(73) Assignee: KONICA MINOLTA BUSINESS TECHNOLOGIES, INC., Tokyo (JP)

(21) Appl. No.: 12/388,014

(22) Filed: Feb. 18, 2009

(30) Foreign Application Priority Data
Feb. 27, 2008 (JP) 2008-045662

(51) Int. Cl. G03G 5/04; G03G 5/00; G03G 13/06; G03G 15/00

(52) U.S. Cl. 430/58.65; 430/73; 430/97; 399/159

(57) ABSTRACT

A mixture of bisamine compounds comprising a bisamine compound represented by Formula (1) and a bisamine compound represented by Formula (2):

A-X-A Formula (1)

A-X—B Formula (2)

wherein, A and B represent a different substituted amino group represented by Formula (3), X represents a bivalent linkage group:

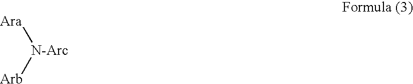

wherein, each of Ara and Arb independently represents an aryl group which may have a substituted group, and Arc represents an arylene group which may have a substituted group, and Ara, Arb and Arc may be combined to form a ring structure.

This application is based on Japanese Patent Application No. 2008-045662 filed on Feb. 27, 2008, in Japanese Patent Office, the entire content of which is hereby incorporated by reference.

### TECHNICAL FIELD

The present invention relates to an electrophotographic photoreceptor and an image forming apparatus, employed in image formation of an electrophotographic system used in such fields as copying machines or printers, and in addition, to a mixture of bisamine compounds employed therein.

### BACKGROUND

Presently, electrophotographic apparatuses employing a laser as a light source, represented by a laser printer, are employed. As a laser of such a light source, semiconductor lasers which emit light exhibiting wavelength of mainly 780 to 800 nm or 680 nm are employed. However, in recent years, higher image quality and higher image resolution of output images have been strongly demanded, and various investigations have been conducted to cope with the above demands. Reducing the spot size of the writing light beam is one of the above investigations. It is theoretically possible to significantly reduce the beam spot by allowing the wavelength of the writing light source shorter, which is very advantageous to increase the writing density of latent images, that is, an increase in resolution. To achieve it, it has been desired to develop an electrophotographic photoreceptor exhibiting high sensitivity and high stability corresponding to LD or LED oscillation light source in the range of 380 to 500 nm.

One of the factors of the development of electrophotographic photoreceptors corresponding to the above short wavelength light source may be development of electron transport materials exhibiting no absorption in the vicinity of a range of 380 to 500 nm of the writing light source. Since most of the currently used electron transfer materials employed in an electrophotographic photoreceptor exhibit absorption in a shorter wavelength region, when such electron transfer materials are employed in the electrophotographic photoreceptor which is exposed by a light source of short wavelength, the sensitivity thereof decreases. To counter such decrease, triarylamine compounds are proposed as an electron transfer material suitable for the electrophotographic photoreceptor which is exposed by a short wavelength light source (refer, for example, to Patent Documents 1 and 2). However, the above compounds exhibit low solubility in the commonly used solvents, so that the coating solution for forming a photosensitive layer of an electrophotographic photoreceptor exhibits poor storage stability, and as a result, tends to precipitate crystals during storage. Therefore, since the above materials are unable to be filled in the electrophotographic photoreceptor at a sufficient concentration to result in generation of a light sensitivity failure or an image failure due to generation of film defects during a durability test, it was difficult to achieve high image quality and high stability.

Patent Document 1: Japanese Patent Application Publication (hereinafter referred to as JP-A) No. 2000-105475

Patent Document 2: JP-A No. 2001-350282

### SUMMARY

### Issues to be Solved by the Invention

The present invention has been achieved in consideration of such problems, and it is an object of the invention to provide an electrophotographic photoreceptor exhibiting high image quality and high durability, an image forming apparatus, and in addition, a mixture of bisamine compounds employed therein.

### Measures to Solve the Issues

The above issues of the present invention can be solved by the constitutions below.

Item 1. A mixture of bisamine compounds comprising a bisamine compound represented by Formula (1) below and a bisamine compound represented by Formula (2) below.

A-X-A Formula (1)

A-X—B Formula (2)

In the formula, A and B represent a different substituted amino group represented by Formula (3) below. X represents a bivalent linkage group.

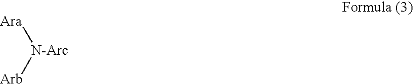

In the formula, each of Ara and Arb independently represents an aryl group which may have a substituted group, and Arc represents an arylene group which may have a substituted group. Ara, Arb and Arc may be combined to form a ring structure.

Item 2. The mixture of bisamine compounds described in Item 1, wherein the mixture of bisamine compounds further contains a bisamine compound represented by Formula (8) below.

B—X—B Formula (8)

Item 3. The mixture of bisamine compounds described in Items 1 or 2, wherein the above bivalent linking group X is represented by Formula (4) below.

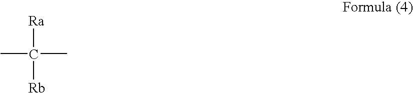

In the formula, each of Ra and Rb independently represents a hydrogen atom, an alkyl group which may have a substituent, an allyl group, or a heterocyclic group, and Ra and Rb may be combined to form a ring structure.

Item 4. The mixture of bisamine compounds described in any one of Items 1-3, wherein the mixture of bisamine compounds is provided by a reaction of at least two kinds of amine compounds represented by Formula (5) below and a ketone compound represented by Formula (6) below.

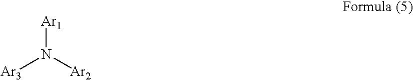

In the formula, each of Ar₁ to Ar₃ independently represents an allyl group which may have a substituent, and Ar₁ to Ar₃ may be combined to form a ring structure.

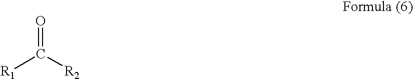

In the formula, each of R₁ and R₂ independently represents a hydrogen atom, an alkyl group which may have a substituent, an allyl group, or a heterocyclic group, and R₁ and R₂ may be combined to form a ring structure.

Item 5. The mixture of bisamine compounds described in Item 4, wherein the mixture of bisamine compounds is provided by a reaction of at least two kinds of amine compounds represented by above Formula (5) and a ketone compound represented by above Formula (6).

Item 6. The mixture of bisamine compounds described in any one of Items 1-5, wherein the mixture of bisamine compounds contains a bisamine compound represented by Formula (7) below.

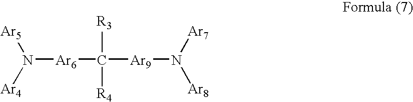

In the formula, each of R₃ and R₄ represents a hydrogen atom, an alkyl group or an allyl group, both of which groups may have a substituent, and R₃ and R₄ may be combined to form a ring structure. Each of Ar₄, Ar₅, Ar₇, and Ar₈ independently represents an allyl group which may have a substituent. Ar₄ and Ar₅ may be combined to form a ring structure, and Ar₇ and Ar₈ may be combined to form a ring structure. Each of Ar₆ and Ar₉ independently represents an arylene group which may have a substituent. Provided that the substituted amino group represented by (Ar₄, Ar₅, and Ar₆)N— differs from the substituted amino group represented by (Ar₇, Ar₈, and Ar₉)N—.

Item 7. The mixture of bisamine compounds described in any one of Items 1-5, wherein X1 and X2 meet Schemes (1) to (3) below, when each content (in percent by mass) of each bisamine compound in the mixture of bisamine compounds is designated as X1, X2, X3, . . . in descending order.

30≦X1+X2<95 Scheme (1)

20≦X1≦95 Scheme (2)

5≦X2≦45 Scheme (3)

Item 8. An electrophotographic photoreceptor comprising a photosensitive layer incorporating a charge generation material and a charge transport material on a conductive substrate, the above charge transport material is a mixture of bisamine compounds described in any one of Items 1-7.

Item 9. The electrophotographic photoreceptor described in Item 8, wherein the above charge generation material is a phthalocyanine compound, a perylene compound, a polycyclic quinone compound, or an azo compound.

Item 10. The electrophotographic photoreceptor described in Item 9, wherein the above charge generation material is a polycyclic quinone compound.

Item 11. An image forming apparatus featuring a light exposure means which forms an electrostatic latent image on the electrophotographic photoreceptor employing a writing light source of a semiconductor laser or a light-emitting diode exhibiting an oscillation wavelength of 380 to 500 nm, and a developing means for making the aforesaid electrostatic latent image visible as a toner image, wherein the electrophotographic photoreceptor is the one described in any one of Items 8-10.

Item 12. A method for forming an image comprising the steps of: (i) forming an electrostatic latent image on the electrophotographic photoreceptor employing a writing light source of a semiconductor laser or a light-emitting diode exhibiting an oscillation wavelength of 380 to 500 nm as an exposure process, and (ii) developing the aforesaid electrostatic latent image to make visible as a developing process, wherein the electrophotographic photoreceptor is one described in any one of Items 8-10.

### EFFECTS OF THE INVENTION

According to the present invention, an electrophotographic photoreceptor exhibiting high image quality and high durability, an image forming apparatus, a method for forming an image, and in addition, a mixture of bisamine compounds employed therein are provide.

### BRIEF DESCRIPTION OF THE DRAWINGS

FIG. 1: A schematic view diagram showing functions of an image forming apparatus of the present invention.

FIG. 2: A cross-sectional configuration view diagram of a color image forming apparatus showing a preferred embodiment of the present invention.

### DESCRIPTION OF THE PREFERRED EMBODIMENTS

In view of the foregoing, the inventors carried out a diligent examination, and as a result, the inventors found that an electrophotographic photoreceptor exhibiting high image quality and high durability can be provided by employing a mixture of bisamine compounds containing the bisamine compound represented by above Formula (1) and the bisamine compound represented by above Formula (2) as a charge transport material. Thus the present invention could be completed.

Compared to an electrophotographic photoreceptor (hereinafter it is simply referred to as a photoreceptor) manufactured by employing a bisamine compound exhibiting low solubility but excellent sensitivity properties, an electrophotographic photoreceptor employing a mixture of a bisamine compound whose amino parts are identical and another bisamine compound one of whose amino part structures was modified can improve the solubility without impairing the sensitivity properties, and prevent image deterioration after durability test. On the other hand, a photoreceptor employing a mixture of bisamine compounds differing completely in their structures caused a decrease in sensitivity and deteriorated initial characteristics.

Table 1 illustrates the above relations.

TABLE 1

| | | | | Image quality |
|---|---|---|---|---|
| | | | | after |
| | | Electric | | durability |
| Bisamine compound | | properties | Solubility | test |
| A-X-A | Single | Excellent | Acceptable | Poor |
| | compound | | | |
| A-X-A | B-Y-B | Acceptable | Excellent | Poor |
| A-X-A | A-X-B | Excellent | Excellent | Excellent |

A & B: sites of substituted amino group structure
X & Y: bivalent linkage groups

The reasons for the above effects are assumed that when one bisamine compound is made by modifying a bisamine compound exhibiting an excellent electric property so as to have the same structure at one of amino parts as well as the same bivalent linkage group, the mixed bisamine compounds exhibit an equivalent electric property, whereby charge passing between the two compounds is readily achieved, and further, the solubility can be dramatically heightened. On the other hand, in a case where two or more types of bisamine compounds differing in their structures, while exhibiting acceptable electric properties, the mixture is assumed to result in degradation in electric properties since the charge passing between compounds is not achieved smoothly, even though the solubility can be increased.

The mixture of a bisamine compound whose amino parts are identical and a bisamine compound, one of whose structures of two amino parts was modified, may be readily provided by a reaction between two or more kinds of amine compounds and a ketone compound during the synthesis thereof.

The present invention is described in detail below.

<<Mixture of Bisamine Compounds>>

In the present invention, as a charge transport material, the bisamine compound represented by above Formula (1) and the bisamine compound represented by above Formula (2) are employed in combination thereof.

In Formulae (1) and (2), A and B denote different substituted amino groups represented by above Formula (3).

In Formula (3), each of Ara and Arb independently represents an aryl group which may have a substituent, and Arc represents an arylene group which may have a substituent. Ara, Arb and Arc may be combined to form a ring structure. The substituent of an aryl group and an arylene group, both of which may have a substituent, includes an alkyl group having a carbon number of 1 to 4, a phenyl group having an alkoxy group, and a biphenyl group. The ring structure formed by a combination of Ara, Arb, and Arc includes a 5 to 6 membered heterocyclic ring.

In Formulae (1) and (2), X is preferably a linkage group represented by above Formula (4).

In Formula (4), each of Ra and Rb independently represents a hydrogen atom, an alkyl group, an aryl group, or a heterocyclic group, which groups may have a substituent, and Ra and Rb may be combined to form a ring structure.

The alkyl group which may have a substituent includes alkyl groups having a carbon number of 1 to 4 such as a methyl group, an ethyl group, an isopropyl group, a 2-methylpropyl group, and an n-butyl group. The substituent of the aryl group includes an alkyl group and an alkoxy group both of which have a carbon number of 1 to 4. The heterocyclic group includes a 5 to 6 membered heterocyclic ring.

The ring structure which may be formed by a linkage of Ra and Rb includes a saturated hydrocarbon ring having a carbon number of 4 to 8 which may have a substituent, and more preferably includes a cyclohexane ring which may have an alkyl group or an aryl group in the ring.

The mixture of bisamine compounds incorporating the bisamine compound represented by Formula (1) and the bisamine compound represented by Formula (2) can be provided by a reaction between two or more kinds of amine compounds represented by above Formula (5) and a ketone compound represented by above Formula (6).

In Formula (5), each of Ar₁ to Ar₃ independently represents an aryl group which may have a substituent, and Ar₁ to Ar₃ may be combined to form a ring structure.

The aryl group which may have a substituent is the same as the one represented by Ara and Arb, both of which were described in Formula (3).

In Formula (6), each of R₁ and R₂ independently represents a hydrogen atom, an alkyl group, an aryl group, or a heterocyclic group, which groups may have a substituent, and R₁ and R₂ may be combined to form a ring structure. The above alkyl group, aryl group, heterocyclic group, and ring structure, all of which may have a substituent, are the same as those represented by Ra and Rb described in Formula (4).

In the mixture of bisamine compounds incorporating the bisamine compound represented by Formula (1) and the bisamine compound represented by Formula (2), when the number of the kind of amine compound represented by above Formula (5) increases during the synthesis, even if the ketone compound represented by Formula (6) is one kind, the kind of the mixture of bisamine compounds rapidly increases to result in a difficulty in regulating their contents. Therefore, it is preferable that the number of the kind of the amine compound represented by Formula (5) is limited to two.

In the present invention, it is preferable that the bisamine compound represented by above Formula (7) is further added into the mixture of bisamine compounds incorporating the bisamine compound represented by above Formula (1) and the bisamine compound represented by above Formula (2).

In Formula (7), each of R₃ and R₄ represents a hydrogen atom, an alkyl group or an aryl group, which groups may have a substituent, and R₃ and R₄ may be combined to form a ring structure. Each of Ar₄, Ar₅, Ar₇, and Ar₈ independently represents an aryl group which may have a substituent, Ar₄ and Ar₅ may be combined to form a ring structure, and Ar₇ and Ar₈ may be combined to form a ring structure. Each of Ar₆ and Ar₉ independently represents an arylene group which may have a substituent. Provided that the substituted amino group represented by (Ar₄, Ar₅, and Ar₆)N— differs from the substituted amino group represented by (Ar₇, Ar₈, and Ar₉)N—.

R₃ and R₄ are the same as Ara and Arb of above Formula (3). Ar₄, Ar₅, Ar₇, and Ar₈ are the same as Ara and Arb of above Formula (3), and Ar₆ and Ar₉ are the same as Arc of above Formula (3).

Since the bisamine compound represented by Formula (7) itself exhibits excellent electric properties and has a similar structure to the mixture of bisamine compounds incorporating the bisamine compound represented by Formula (1) and the bisamine compound represented by Formula (2) of the present invention, solubility and electric properties of the mixture of bisamine compounds are improved in combination with the above bisamine compound represented by Formula (7).

Although one kind of the compound of Formula (1) and one kind of the compound of Formula (2) are usually employed in combination, an analogous compound which is obtained as a by-product during the synthesis such as a compound having a formula of B—X—B may be employed in combination thereof. In such a case, it is preferable that X1 and X2 meet Schemes (1) to (3) below, when each content (in percent by mass) of each bisamine compound in the mixture of bisamine compounds is designated as X1, X2, X3, . . . in descending order.

30≦X1+X2<95 Scheme (1)

20≦X1≦95 Scheme (2)

5≦X2≦45 Scheme (3)

In other words, the content of the primary constituent is preferably at least 20% by mass. When the above content is less than 20% by mass, stability of the coating solution thereof may become deteriorated. Further, the total content of the primary and the secondary constituents is preferably at least 30% by mass. For example, when the contents of A-X-A, A-X—B, and B—X—B (wherein A and B are amino groups, and X is a bivalent linking group) are defined to be X1, X2, and X3 respectively, it is preferable that the content of an analogous compound B—X—B, which is produced as a by-product during synthesis, is made to be at most 30% by mass. By selecting a content ratio of amine compounds and the reaction conditions during the synthesis, it is possible to control the content of each bisamine compound in the mixture of bisamine compounds so as to meet Schemes (1) to (3). The preparative chromatography treatment can also be made to control the above content to meet Schemes (1) to (3). Further, by adding A-X-A and B—X—B, each of which is separately synthesized, into the mixture of bisamine compounds, the content may also be controlled to meet Schemes (1) to (3).

A charge transport material, other than the mixture of the bisamine compounds represented by Formula (1) and the bisamine compound represented by Formula (2), can be employed in combination. However, in general, only the bisamine compound represented by Formula (1), the compound represented by Formula (2) and a by-product produced at the synthesis are employed.

The mixture of bisamine compounds of the present invention can be synthesized by a condensation reaction between two kinds of amine compounds and a ketone compound such as described below.

### Amine Compounds

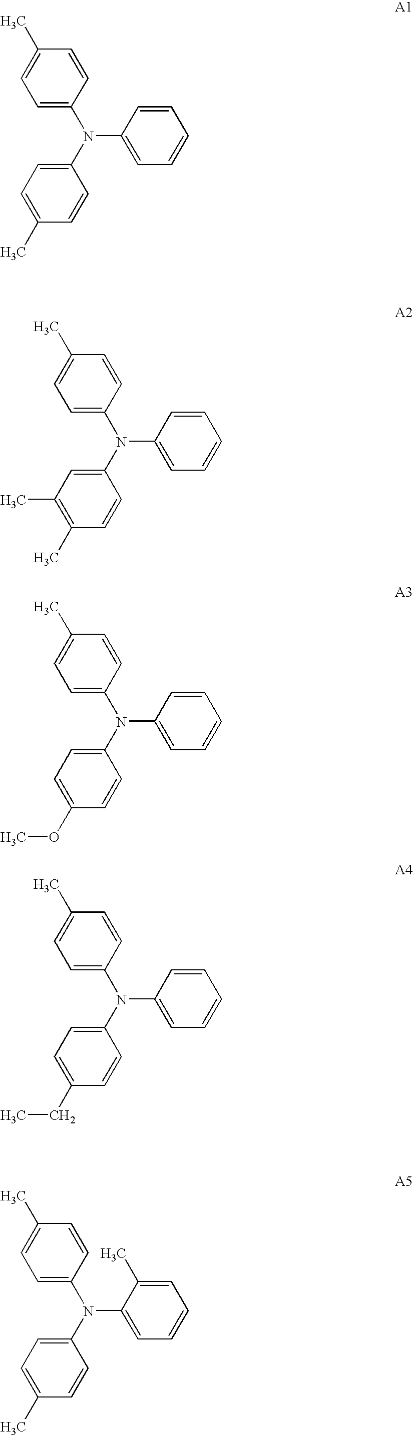

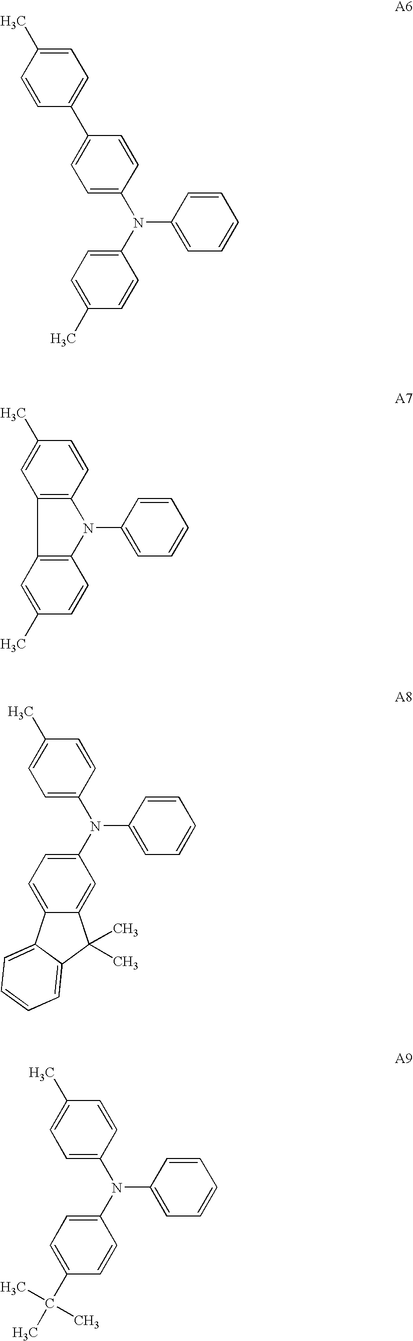

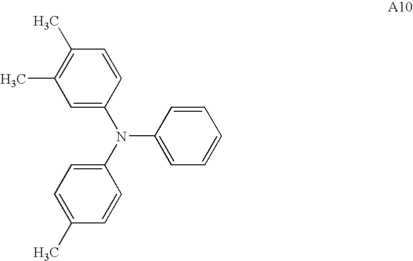

### Ketone Compounds

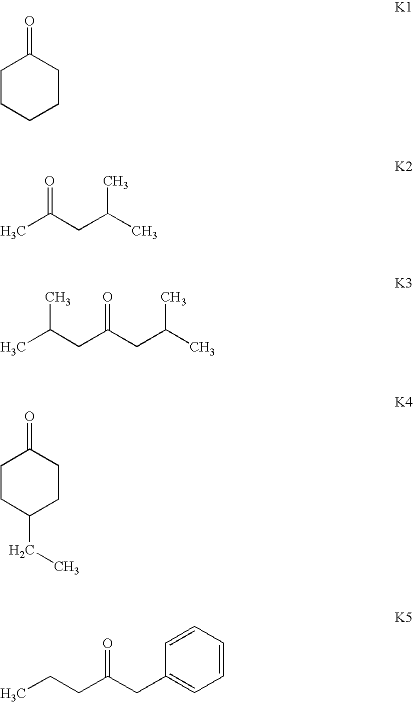

<<Photoreceptor>>

The photoreceptor of the present invention incorporates a mixture of the bisamine compound represented by above Formula (1) and the bisamine compound represented by above Formula (2) as charge transport materials. Constitutions of the photoreceptor incorporating the above charge transport materials are described below.

In the present invention, the term “photoreceptor” means a photoreceptor which is constituted of organic compounds having at least one of functions of a charge generation and charge transport both of which are essential for the constitution of the photoreceptor, and it covers all commonly known photoreceptors such as a photoreceptor constituted of a commonly known charge generation material or a charge transport material, and a photoreceptor in which both functions of the charge generation and charge transport are constituted of a polymer complex.

The constitution of the photoreceptor of the present invention is not particularly limited as long as it incorporates the bisamine compound represented by above Formula (1) and the compound represented by above Formula (2) (a charge transport material), and, for example, it includes constitutions described below;

1) a constitution in which a charge generation layer and a charge transport layer are successively laminated as a photosensitive layer on a conductive substrate;

2) a constitution in which a charge generation layer, the first charge transport layer and the second charge transport layer are successively laminated as a photosensitive layer on a conductive substrate;

3) a constitution which forms a single layer incorporating a charge transport material and a charge generation material as a photosensitive layer on a conductive substrate;

4) a constitution in which a charge transport layer and a charge generation layer are successively laminated as a photosensitive layer on a conductive substrate; and

5) a constitution in which, on the photosensitive layer of the above photoreceptors 1) to 4), a surface protective layer is further formed.

The photoreceptor may have any of the above constitutions. The term “surface layer” of the photoreceptor denotes a layer at which the photoreceptor is in contact with an air interface. In a case where only a photosensitive layer of a single layer type is formed on a conductive substrate, the aforesaid photosensitive layer is the surface layer, and in a case where laminated photosensitive layers and a surface protective layer are laminated on a conductive substrate, the surface protective layer is the outermost surface layer. In the present invention, above Constitution 2) is most preferably employed. In the photoreceptor of the present invention, which may have any constitution, an undercoat layer (an interlayer) may be formed on the conductive substrate before the photosensitive layer is formed.

The term “charge transport layer” means that the layer has a function of transporting charge carriers generated in the charge generation layer by light exposure. The specific detection of the aforesaid charge transport function can be confirmed by a detection of light conductivity in the conductive substrate on which a charge generation layer and a charge transport layer are laminated.

Next, a layer constitution of the photoreceptor is described by focusing on above Constitution 1).

(Conductive Substrate)

As a conductive substrate employed for the photoreceptor, either sheet-shaped or cylindrical one may be employed, but the cylindrical conductive substrate is preferred to design a compact image forming apparatus.

The cylindrical conductive substrate means a cylindrical support necessary to form images endlessly by rotation, and it is preferable that the conductive support exhibiting a straightness of not more than 0.1 mm and a deflection not more than 0.1 mm. If the straightness or the deflection is over the above ranges, it becomes difficult to form excellent images.

As a conductive substrate, a metallic drum made of metals such as aluminum, nickel, a plastic drum on which a conductive material such as aluminum, tin oxide, and indium oxide is vapor-deposited, and a paper or plastic drum coated with conductive material may be employed. As a conductive substrate, the resistivity thereof is preferably not more than 10³ ohm-cm at ordinary temperature. An aluminum support is most preferable as the conductive substrate to be employed for the present invention. For the aforesaid aluminum support, a mixture of constituents such as manganese, zinc, and magnesium with aluminum which is the primary constituent may also be employed.

(Interlayer)

In the present invention, an interlayer is preferably provided between a conductive substrate and a photosensitive layer. As the binder resin of the interlayer, an alcohol-soluble polyamide resin is preferable. As the binder resin of the interlayer of the photoreceptor, a resin which is superior in the solubility in solvent is necessary for forming the interlayer having a uniform layer thickness. As such the alcohol-soluble polyamide resin, copolymerized polyamide resins constituted with a chemical structure having a short carbon chain between amide bonds such as 6-Nylon, or methoxymethylized polyamide resins are employed.

The interlayer to be employed in the present invention preferably contains n-type semiconductor particles. The aforesaid term “n-type semiconductor particles” means particles in which the main charge carrier is an electron. Thus, since the main charge carrier is an electron, an interlayer in which the aforesaid n-type semiconductor particles are incorporated in an insulating binder has characteristics such that it efficiently blocks hole-injection from the substrate and exhibits less blocking of electrons from the photosensitive layer.

As the n-type semiconductor particles, titanium oxide (TiO₂) and zinc oxide (ZnO) are preferred, and titanium oxide is particularly preferably employed.

The volume ratio of the n-type semiconductor particles in the interlayer is preferably 1.0 to 2.0 times that of the binder resin in the interlayer (with reference to the binder volume being 1). Employment of the n-type semiconductor particles of the present invention in such a high density in the interlayer enhances the rectifying property of the interlayer, and effectively prevents an increase in residual potential or deterioration of dot images even if the film thickness is increased, enabling an excellent photoreceptor. In such an interlayer, the volume of n-type semiconductor particles to be employed is preferably 100 to 200 parts by volume with reference to the binder resin volume being 100 parts by volume.

(Photosensitive Layer)

The photosensitive layer constitution of the photoreceptor of the present invention may be a photosensitive layer constitution of a single-layer structure featuring a charge generation function and a charge transport function in one layer on the above-described interlayer, but more preferably a constitution in which the functions of the photosensitive layer are separated into a charge generation layer (CGL) and a charge transport layer (CTL). Adoption of the constitution with the separated functions can reduce an increase of residual potential which is caused by repeated uses, and readily control other electrographic characteristics to meet targeted purposes. In a photoreceptor employing a negative charge, it is preferable to adopt a constitution in which a charge generation layer (CGL) is formed on an interlayer and a charge transport layer (CTL) is then set thereon.

The photosensitive layer constitution of a photoreceptor for negative charging with separated functions is described below.

(Charge Generation Layer)

In the photoreceptor of the present invention, it is preferable to employ a charge generation material exhibiting high sensitivity characteristics in the wavelength region of from 380 to 500 nm. In the present invention, as a charge generation material such as described above, compounds such as a phthalocyanine compound, a perylene compound, a polycyclic quinone compound, and an azo compound are preferably employed. Those compounds can also be employed in combination thereof.

The usable phthalocyanine compound includes titanyl phthalocyanine pigments having high sensitivity properties to a long wavelength LED or laser light; gallium phthalocyanines such as a hydroxygallium phthalocyanine (JP-A No. H5-263007) and a chlorogallium phthalocyanine; A-type titanyl phthalocyanines having a maximum peak at 26.3 degree in a x-ray diffraction spectrum (with a tolerance of ±0.2 degree) (JP-A No. S62-97064); B-type titanyl phthalocyanines having characteristic peaks at 7.6 and 28.6 degree (JP-A No. S61-239248); Y-type titanyl phthalocyanines having a maximum peak at 27.3 degree (JP-A No. H3-35245); and titanyl phthalocyanines known as a titanyl phthalocyanine adduct of a 2,3-butanediol having stereoregularity (JP-A No. H8-82942). Among them, a Y-type titanyl phthalocyanine (y-TiOPc) is preferred.

The perylene compound includes compounds described below.

### Perylene Compounds

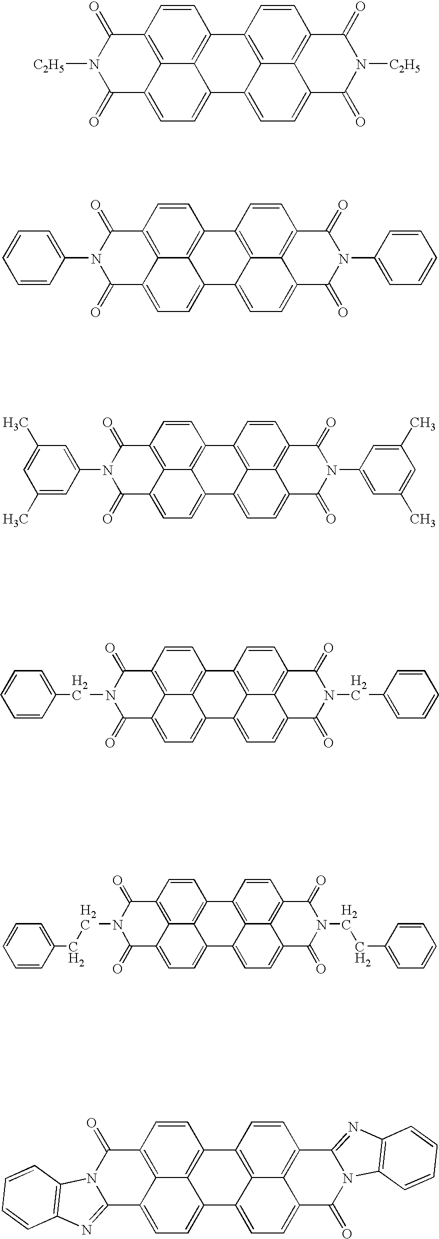

The polycyclic quinone compound includes compounds represented by CGM formulae (1) to (3) described below.

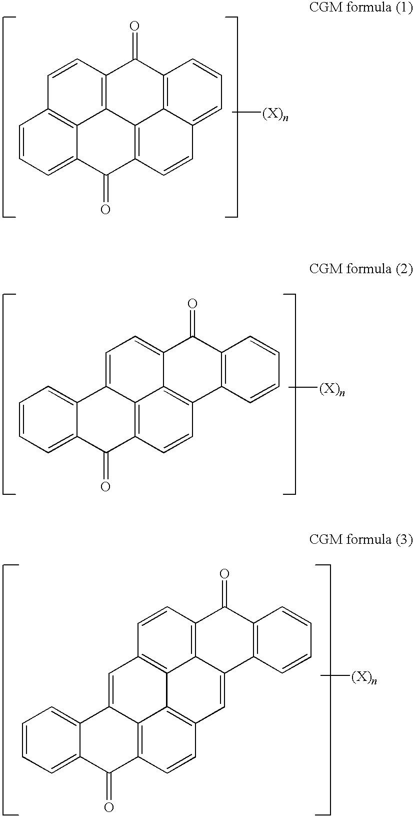

In CGM formulae (1) to (3), X represents a halogen atom, an alkyl group, a nitro group, a cyano group, an acyl group or a carboxyl group, n represents an integer of 0 to 4, and m represents an integer of 0 to 6.

Specific examples of the polycyclic quinone compound are illustrated below.

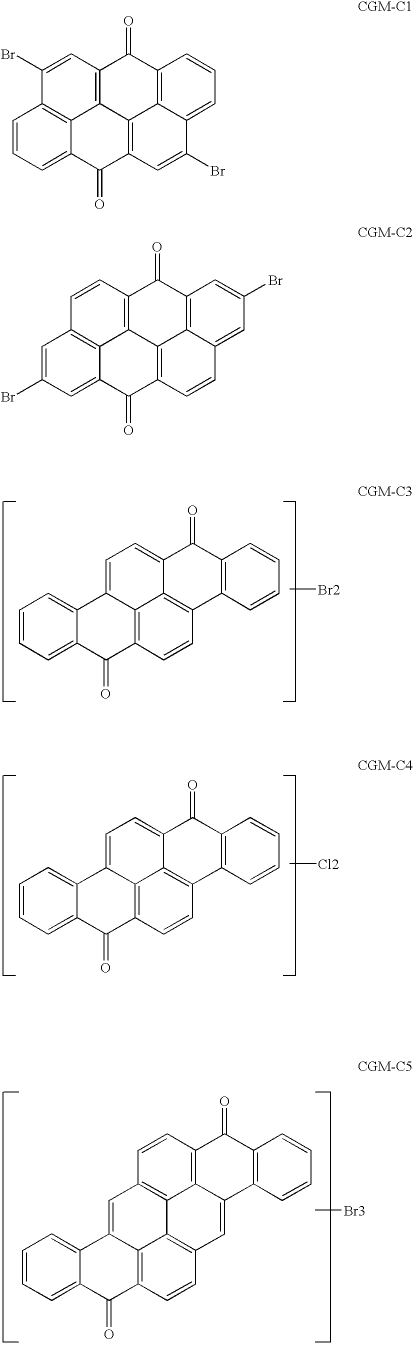

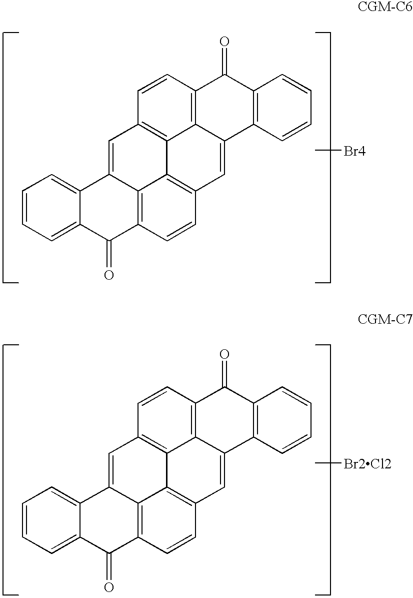

Since the means to correctly identify substitution positions of halogen atoms in CGM-C3 to CGM-C7 is not established, it is difficult to correctly identify substitution positions. However, it is preferable that CGM-C3 and CGM-C4, and CGM-C5 to CGM-C7 have at least substituted compounds at 1 and 7 positions, and 1, 4, 8, and 11 positions, respectively.

The preferred azo compounds are represented by Formula (8) below.

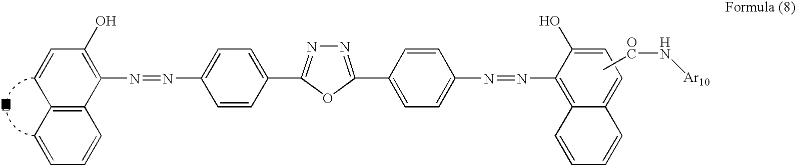

In Formula (8), Ar₁₀ represents an aryl group which may have a substituent, and Z represents a mixture of compounds below.

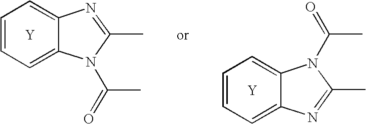

The aromatic six-membered ring Y may have a substituent.

The preferred charge generation materials are represented by Formula (9) below.

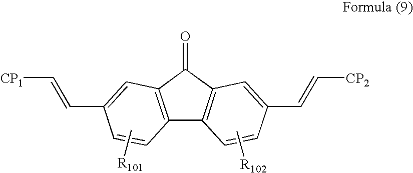

In Formula (9), Cp₁ and Cp₂ represent a coupler residue. Each of R₁₀₁ and R₁₀₂ represents a hydrogen atom, an alkyl group, an alkoxy group, or a cyano group, and the R₁₀₁ and R₁₀₂ may be the same or different. The Cp₁ and Cp₂ are represented by Formula (10) below.

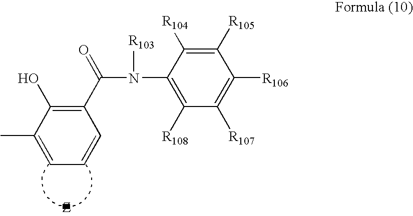

In Formula (10), R₁₀₃ represents a hydrogen atom, an alkyl group, or an aryl group. Each of R₁₀₄, R₁₀₅, R₁₀₆, R₁₀₇, and R₁₀₈ represents a hydrogen atom, a nitro group, a cyano group, a halogen atom, a halogenated alkyl group, an alkyl group, an alkoxy group, a dialkylamino group, or a hydroxyl group. Z represents a substituted or nonsubstituted aromatic carbon ring, or atom groups necessary to form a substituted or nonsubstituted aromatic heterocycle.

In the present invention, the phthalocyanine compound, the polycyclic quinone compound, or the azo compound is preferred. Those compounds have crystal structures, which are capable of forming a stable aggregation structure among a plurality of molecules, exhibit nearly no deterioration associated with the repeated use, and can reduce the increase of residual potential.

When a binder is employed in the charge generation layer as a dispersing medium of CGM, commonly known resins may be used as the binder, but resins such as formal resins, butyral resins, silicone resins, silicone-modified butyral resins, and phenoxy resins are most preferably employed. The ratio between binder resins and charge generation materials is preferably from 20 to 600 parts by mass with reference to the binder resins being 100 parts by mass. Employment of these resins can minimize the increase in residual potential which is caused by repeated uses. The film thickness of the charge generation layer is preferably from 0.3 to 2 μm.

(Charge Transport Layer)

The charge transport layer incorporates the charge transport material (CTM) and a binder resin for dispersing the CTM and forming the layer. Another material such as an anti-oxidation agent may be incorporated if necessary.

As the charge transport material (CTM), the bisamine compound represented by above Formula (1) and the charge transport material represented by above Formula (2) may be employed, and in addition to the above materials, a commonly known positive hole transport type (P type) charge transport material (CTM) may be employed in combination with the above materials. Usable examples include triphenylamine derivatives, hydrazone compounds, styryl compounds, benzidine compounds, and butadiene compounds. These charge transport materials are usually dissolved in a suitable binder resin to form a layer.

As the binder resin employed for the charge transport layer (CTL), either of thermoplastic resin or thermosetting resin can be employed. Examples of the resin include polystyrene resins, acryl resins, methacryl resins, vinyl chloride resins, vinyl acetate resins, polyvinyl butyral resins, epoxy resins, polyurethane resins, phenol resins, polyester resins, alkyd resins, polycarbonate resins, silicone resins, melamine resins, and copolymer resins containing two or more of the repeating units of these resins. Other than the above insulation resins, organic semi-conductive polymers such as a poly-N-vinylcarbazole are employable. Among them, a polycarbonate resin, which exhibits a small water absorption rate, and excellent dispersibility of CTM and electrophotographic properties, is most preferred.

The ratio between the binder resin and the charge transport material is that the charge transport material is preferably 50 to 200 parts by mass with reference to the binder resin being 100 parts by mass.

The total thickness of the charge transport layer is preferably from 10 to 25 μm. When the aforesaid layer thickness is less than 10 μm, it is difficult to secure sufficient latent image potential during development, resulting in a tendency of decreasing image density or degrading dot reproducibility, while when the aforesaid layer thickness exceeds 25 μm, dispersion of charge carriers (dispersion of charge carriers generated at the charge generation layer) increases, resulting in a tendency of degrading dot reproducibility. The thickness of the charge transport layer, which functions as the surface layer, is preferably from 1.0 to 8.0 μm.

The solvents or the dispersion media employed to form layers such as the interlayer, the charge generation layer, or the charge transport layer include n-butylamine, diethylamine, ethylenediamine, isopropanolamine, triethanolamine, triethylenediamine, N,N-dimethylformamide, acetone, methyl ethyl ketone, methyl isopropyl ketone, cyclohexanone, benzene, toluene, xylene, chloroform, dichloromethane, 1,2-dichloroethane, 1,2-dichloropropane, 1,1,2-trichloroethane, 1,1,1-trichloroethane, trichloroethylene, tetrachloroethane, tetrahydrofurane, dioxolane, dioxane, methanol, ethanol, buthanol, isopropanol, ethyl acetate, butyl acetate, dimethyl sulfoxide, and methyl cellosolve. The present invention is not restricted to them, and earth-friendly solvents such as tetrahydrofurane, and methyl ethyl ketone are preferably employed. Further, these solvents may also be employed either independently or as a mixture of two or more thereof.

Next, the usable coating and processing methods for producing the photoreceptor include, in addition to a slide hopper type coating apparatus, a dipping coating, or a spray coating. A circular slide hopper type coating apparatus is most preferably employed to form a surface layer.

Next, the image forming apparatus employing the photoreceptor of the present invention will be described.

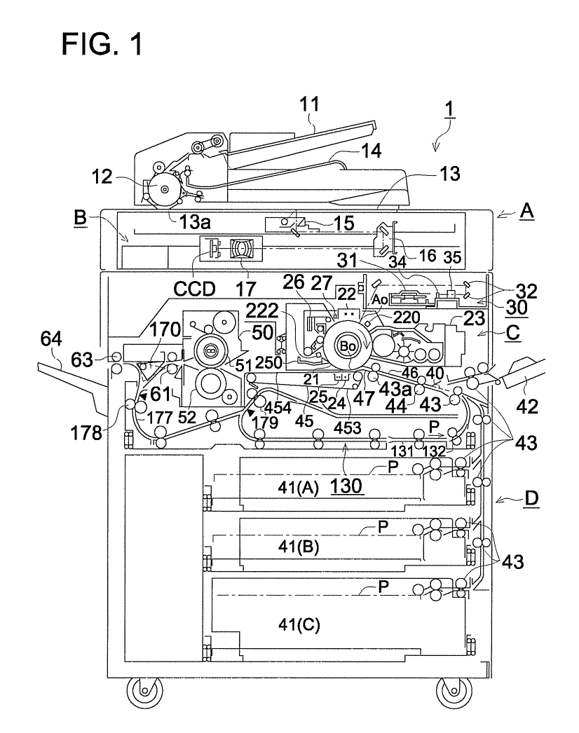

Image forming apparatus 1 as shown in FIG. 1 is an image forming apparatus by digital system, and is constituted with image reading part A, image processing part B, image forming part C, and image receiving paper conveying part D as an image receiving paper conveying means.

On image reading part A, there is provided an automatic document feeding means, which automatically feed a document, and document sheets placed on document placement table 11 are separated and conveyed one by one by document conveyance roller 12, and then the image reading is carried out at reading position 13a. The document sheet, whose image having been read, is ejected onto document output tray 14 by document conveyance roller 12.

In the meantime, the image of the document sheet placed on platen glass 13 is read by reading motion at a speed of v of first mirror unit 15 comprised of an illumination lamp and the first mirror, which unit constitutes scanning optical system, and by movement in the same direction at a speed of v/2 of second mirror unit 16 comprised of second and third mirrors configured in a v-shaped position.

The above image which has been read is formed on the image receiving surface of an image sensor CCD, which is a line sensor, through projection lens 17. The line-shaped optical images formed on the image sensor CCD are sequentially subjected to a photoelectric conversion into electrical signals (brightness signals), which are then subjected to an A/D conversion, and then the image data are once stored in a memory after being subjected to processing such as a density transformation and a filter processing in image processing part B.

In image forming part C, as an image forming unit, drum-shaped photoreceptor 21 as an image carrying member is provided, and around photoreceptor 21, charging means 22 (a charging step) for charging aforesaid photoreceptor 21, electric potential detecting means 220 for detecting the surface potential of the charged photoreceptor, a developing means 23 (a developing step), transfer conveyance belt device 45 as a transfer means (a transfer step), cleaning device 26 for above photoreceptor 21 (a cleaning step), and PCL (a pre-charging exposure lamp) 27 as a photo-discharging means (a photo-discharging step) are configured in the order of their operation. Further, at the downstream side of developing means 23, there is provided reflection density detecting means 222 for measuring the reflection density of a patch image developed on photoreceptor 21. The photoreceptor of the present invention is employed for photoreceptor 21, which is driven to rotate in the clockwise direction as shown in the drawing.

Rotating photoreceptor 21, after having been subjected to a uniform charging by charging means 22, is subjected to an image exposure based on the image signal which was read out from the memory in image processing part B by means of an exposure optical system as image exposure means 30 (an image exposure step). The exposure optical system as image exposure means 30, which is a writing means, has a laser diode (not illustrated) as a light emitting light source, and the main scanning is carried out with the light passing through rotary polygonal mirror 31, fθ lens 34, and cylindrical lens 35, and then with its optical path being deflected by reflection mirror 32. The image exposure to photoreceptor 21 is carried out at position Ao, and an electrostatic latent image is formed by the rotation of photoreceptor 21 (sub-scanning). In an example of the present embodiment, the character part of an image is exposed to light to form an electrostatic latent image.

In the image forming apparatus of the present invention, when an electrostatic latent image is formed on the photoreceptor, a semiconductor laser or a light-emitting diode exhibiting an oscillation wavelength of 380 to 500 nm is employed as an image exposure light source. The exposure dot size in the main scanning direction of writing is narrowed down to 10 to 50 μm, and then by carrying out a digital exposure to the photoreceptor with the light, an electrophotographic image with high resolution of from at least 600 to 2,500 dpi (dpi: number of dots per 2.54 cm) can be obtained.

The above-described term “exposure dot size” denotes an exposure beam length (Ld: determined at the maximum length position) along a main scanning direction in the area where the aforesaid exposure beam intensity is 1/e² or more of the peak intensity.

The usable light beam includes the beams of the scanning optical system employing a semi-conductor laser and a solid scanner such as LED. The light intensity distribution includes Gaussian distribution and Lorenz distribution, and in either case, the each area where the intensity is 1/e² or more of the peak intensity is assumed to be the exposure dot size of the present invention.

The electrostatic latent image on photoreceptor 21 is subjected to reverse development by developing means 23, and a visible toner image is formed on the surface of photoreceptor 21. In the image forming method of the present invention, polymerized toner is preferably employed as the developer for the aforesaid developing means. An electrophotographic image exhibiting more excellent sharpness can be achieved when the polymerized toner exhibiting a uniform shape and a uniform particle size is employed in combination with the photoreceptor of the present invention.

In transfer paper conveyance section D, sheet feed units 41(A), 41(B) and 41(C) as a transfer sheet storage means are arranged below the image forming unit, wherein transfer sheets P having different sizes are stored. Manual sheet feed unit 42 for manual feed of the sheets of paper is provided on the photoreceptor side. Transfer sheets P selected from any one of the units are fed along sheet conveyance path 40 by guide roller 43, and are temporarily suspended by a pair of sheet feed registration rollers 44 for correcting the inclination and deviation of transfer sheets P. Then transfer sheets P are again fed and guided by sheet conveyance path 40, pre-transfer roller 43a, paper feed path 46 and entry guide plate 47. Then the toner image on photoreceptor 21 is transferred to transfer sheet P at transfer position Bo by transfer electrode 24 and separator electrode 25, while aforesaid transfer sheet P is separated from the surface of photoreceptor 21 and is conveyed to fixing means 50 by transfer/conveyance belt apparatus 45.

Fixing means 50 contains fixing roller 51 and pressure roller 52. When transfer sheet P passes between fixing roller 51 and pressure roller 52, the toners are fixed by heat and pressure. With the toner image having been fixed thereon, transfer sheet P is ejected onto sheet discharge tray 64.

The above description is concerned with the case where an image is formed on one side of the transfer sheet. In the case of duplex copying, ejection switching member 170 is switched, and transfer sheet guide 177 is opened, and then, transfer sheet P is conveyed in the direction of an arrow showed in a broken line.

Further, transfer sheet P is conveyed downward by conveyance device 178, and is switched back by sheet reversing section 179. With the trailing edge of transfer sheet P becoming the leading edge, transfer sheet P is conveyed into sheet feed unit for duplex copying 130.

Transfer sheet P is moved along conveyance guide 131 provided on sheet feed unit for duplex copying 130 in the direction of sheet feed, and then transfer sheet P is fed again by sheet feed roller 132 and is led to sheet conveyance path 40.

As described above, transfer sheet P is again conveyed in the direction to photoreceptor 21, and the toner image is transferred on the reverse side of transfer sheet P. After the image is fixed by fixing means 50, transfer sheet P is ejected to ejection tray 64.

The image forming apparatus of the present invention may be configured in such a way that the components such as the aforementioned photoreceptor, developing device and cleaning device are integrally combined into a process cartridge, and this unit may be mounted on the apparatus proper as a removable unit. It is also possible to arrange such a configuration that at least one of the charging device, the image exposure device, the developing device, the transfer or separator device, and the cleaning device is supported integrally with the photoreceptor, so as to form a process cartridge which, as a removable single unit, is mounted on the apparatus proper, using a guide means such as a rail of the apparatus proper.

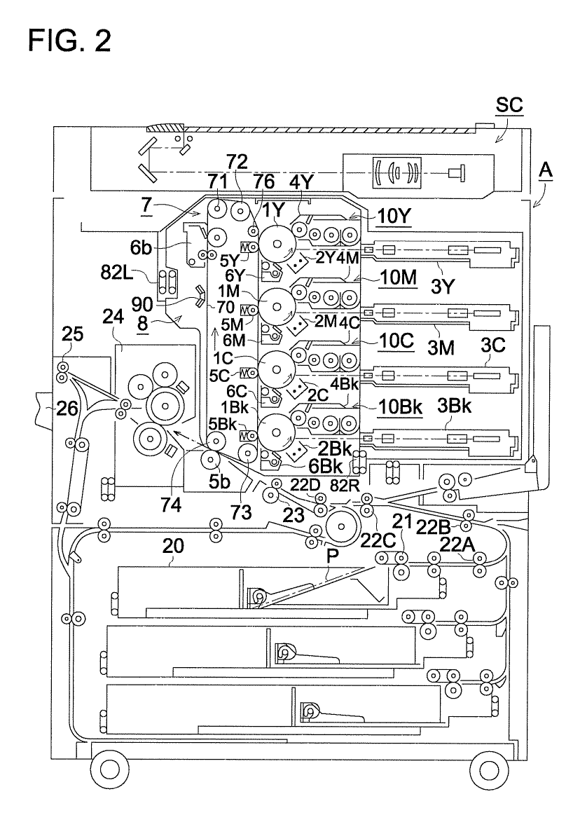

FIG. 2 is a cross-sectional configuration view diagram of a color image forming apparatus showing a preferred embodiment of the present invention.

This color image forming apparatus is of the so called tandem type color image forming apparatus, and comprises four sets of image forming sections (image forming units) 10Y, 10M, 10C, and 10Bk, endless belt shaped intermediate image transfer body unit 7, sheet feeding and conveyance means 21, and fixing means 24. Original document reading apparatus SC is placed on top of main unit A of the image forming apparatus.

Image forming section 10Y, which forms images of yellow color, comprises charging means (a charging step) 2Y, exposing means (an exposing step) 3Y, developing means (a developing step) 4Y, primary transfer roller 5Y as a primary transfer means (a primary transfer step), and cleaning means 6Y, all of which are arranged around drum shaped photoreceptor 1Y which acts as the first image-carrying body. Image forming section 10M, which forms images of magenta color, comprises drum shaped photoreceptor 1M which acts as the first image-carrying body, charging means 2M, exposing means 3M, developing means 4M, primary transfer roller 5M as a primary transfer means, and cleaning means 6M. Image forming section 10C, which forms images of cyan color, comprises drum shaped photoreceptor 1C which acts as the first image-carrying body, charging means 2C, exposing means 3C, developing means 4C, primary transfer roller 5C as a primary transfer means, and cleaning means 6C. Image forming section 10Bk, which forms images of black color, comprises drum shaped photoreceptor 1Bk which acts as the first image-carrying body, charging means 2Bk, exposing means 3Bk, developing means 4Bk, primary transfer roller 5Bk as a primary transfer means, and cleaning means 6Bk.

Above-described four sets of image forming units 10Y, 10M, 10C, and 10Bk are constituted, centering on photoreceptor drums 1Y, 1M, 1C, and 1Bk, by rotating charging means 2Y, 2M, 2C, and 2Bk, image exposing means 3Y, 3M, 3C, and 3Bk, rotating developing means 4Y, 4M, 4C, and 4Bk, and cleaning means 5Y, 5M, 5C, and 5Bk which clean photoreceptor drums 1Y, 1M, 1C, and 1Bk.

Image forming units 10Y, 10M, 10C, and 10Bk, all of which have the same configuration except that the color of the toner image formed in each unit is different on respective photoreceptor drums 1Y, 1M, 1C, and 1Bk. Therefore, the detailed description is given below taking the example of image forming unit 10Y.

Image forming unit 10Y has, placed around photoreceptor drum 1Y which is the image forming body, charging means 2Y (hereinafter referred to merely as charging means 2Y or charging device 2Y), exposing means 3Y, developing means 4Y, and cleaning means 5Y (hereinafter referred to merely as cleaning means 5Y or as cleaning blade 5Y), and forms yellow (Y) colored toner image on photoreceptor drum 1Y. Further, in the present preferred embodiment, at least photoreceptor drum 1Y, charging means 2Y, developing means 4Y, and cleaning means 5Y among above image forming unit 10Y are provided in an integral manner.

Charging means 2Y is a means which applies a uniform electrostatic potential to photoreceptor drum 1Y, and corona discharge type charging device 2Y is being employed for photoreceptor drum 1Y in the present preferred embodiment.

Image exposing means 3Y is a means which carries out light exposure, based on the image signal (yellow), on photoreceptor drum 1Y to which a uniform potential has been applied by charging device 2Y, and forms the electrostatic latent image corresponding to the yellow color image. As exposing means 3Y, devices such as a device constituted of LEDs and imaging elements (product name: SELFOC LENSES) in which light emitting devices are arranged in an array configuration in the axial direction of photoreceptor drum 1Y or a laser optical system are employed.

The image forming apparatus of the present invention may be configured in such a way that the components such as the aforementioned photoreceptor, the developing device and the cleaning device are integrally combined into a process cartridge (an image forming unit), and this image forming unit is mounted on the apparatus proper as a removable unit. It is also possible to arrange such a configuration that at least one of the charging device, the image exposure device, the developing device, the transfer or separator device, and the cleaning device is supported integrally with the photoreceptor, so as to form a process cartridge (an image forming unit) which, as a removable single image forming unit, is mounted on the apparatus proper, using a guide means such as a rail of the apparatus proper.

Endless belt shaped intermediate image transfer body unit 7 is wound around a plurality of rollers, and has endless belt shaped intermediate image transfer body 70 which acts as the second image-carrying body in the shape of a partially conducting endless belt which is supported in a free manner to rotate.

The images of different colors formed by image forming units 10Y, 10M, 10C, and 10Bk, are successively transferred onto rotating endless belt shaped intermediate image transfer body 70 by primary transfer rollers 5Y, 5M, 5C, and 5Bk acting as the primary image transfer means, thereby forming the synthesized color image. Transfer material P as the transfer material stored inside sheet feeding cassette 20 (the supporting body that carries the final fixed image: for example, plain paper, and transparent sheet) is fed from sheet feeding means 21, passes through a plurality of intermediate rollers 22A, 22B, 22C, and 22D, and registration roller 23, and is transported to secondary transfer roller 5b which functions as the secondary image transfer means, whereby secondary transfer is performed onto transfer material P and several color images are collectively transferred. Transfer material P on which the color image has been transferred is subjected to a fixing process by fixing means 24, and is gripped by sheet discharge rollers 25 and placed on sheet discharge tray 26 outside the equipment. Here, the transfer supporting body of the toner image formed on the photoreceptor, which body includes the intermediate transfer body or the transfer material, is comprehensively called the transfer media.

On the other hand, after the color image is transferred to transfer material P by secondary transfer roller 5b functioning as the secondary transfer means, endless belt shaped intermediate image transfer body 70, from which transfer material P was separated due to different radii of curvature, is cleaned by cleaning means 6b to remove all residual toner on it.

During the image forming process, primary transfer roller 5Bk is always brought into pressure contact with photoreceptor 1Bk. Other primary transfer rollers 5Y, 5M, and 5C are brought into pressure contact with each of corresponding photoreceptors 1Y, 1M, and 1C only when a color image is being formed.

Secondary transfer roller 5b is brought into pressure contact with endless belt shaped intermediate transfer body 70 only when the secondary transfer is to be made by passing transfer material P through this.

Further, chassis 8 can be pulled out via supporting rails 82L and 82R from apparatus proper A.

Chassis 8 is composed of image forming sections 10Y, 10M, 10C, and 10Bk, and endless belt shaped intermediate image transfer body unit 7.

Image forming sections 10Y, 10M, 10C, and 10Bk are arranged in column in the vertical direction. Endless belt shaped intermediate image transfer body unit 7 is placed to the left side in the figure of photoreceptor drums 1Y, 1M, 1C, and 1Bk. Endless belt shaped intermediate image transfer body unit 7 is composed of endless belt shaped intermediate image transfer body 70 which can rotate around rollers 71, 72, 73, and 74, primary image transfer rollers 5Y, 5M, 5C, and 5Bk, as well as cleaning means 6b.

The image forming apparatus of the present invention can be applied in general to electrophotographic apparatuses such as electrophotographic copiers, laser printers, LED printers, as well as liquid crystal shutter type printers, and in addition, it is also possible to apply the present invention to a wide range of apparatuses applying electrophotographic technology, such as displays, recorders, light printing equipment, printing screen production, as well as facsimile equipment.

### EXAMPLES

The present invention will now be described in detail referring to examples. However, the present invention is not limited thereto. The “part” in the description below represents “part by mass”.

### Example

### Synthesis of Mixture of Bisamine Compounds

(Synthesis of Compound of Present Invention: CTM1)

An example of the synthesis of the mixture of bisamine compounds of the present invention will be described referring to a reaction formula below.

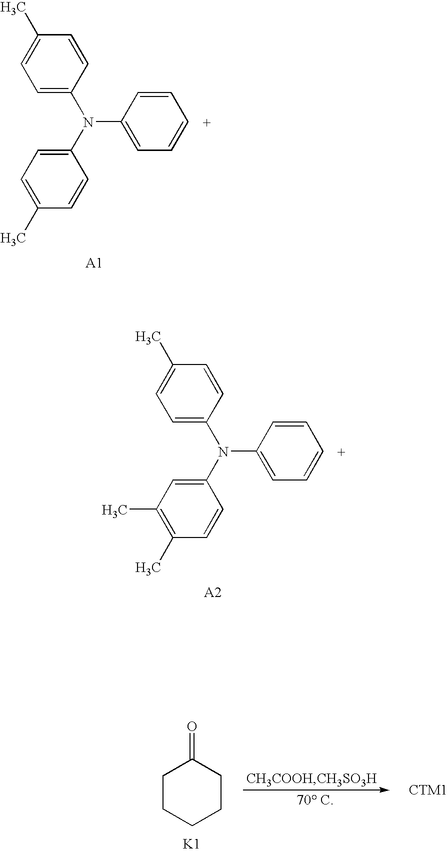

A 300 ml three necked flask equipped with a condenser, a thermometer, and a nitrogen introduction tube was decompressed, and then the flask was subjected to a complete nitrogen gas substitution. After that, the flask was charged with 9 g of N,N-bis(p-methylphenyl)aniline, 10 g of N,N-bis(3,4-dimethylphenyl)aniline, 9.8 g of cyclohexanone, 25 ml of acetic acid, and 0.65 g of methane sulfonic acid, and the resulting solution was stirred at 70° C. under nitrogen gas stream. After 10 hours, the reaction was terminated, a liquid of 300 ml of toluene and 200 ml of water was added into the flask, and then the aqueous phase of the resulting solution was rinsed using a separatory funnel until the aqueous phase was neutralized. The toluene phase was removed, dried with anhydrous magnesium sulfate, and then condensed. The targeted mixture of bisamine compounds was removed via a column chromatography, recrystallized using ethyl acetate, to prepare 7.3 g of exemplified compound CTM1. The composition of the compound was determined via measurement employing a high speed liquid chromatography to be a mixture incorporating CTM1a (A-X-A type), CTM1b (A-X—B type), and CTM1c (B—X—B type) in a composition ratio of CTM1a/CTM1b/CTM1c=28/43/29 (percent by mass). In the present invention, the area ratio of each constituent determined under conditions below is defined as percent by mass. The conditions for a measurement apparatus, a column, and a mobile phase may be altered as long as the clear separation of the mixture can be achieved.

The measurement conditions of a high speed liquid chromatography are described below.

Measurement apparatus (high speed liquid chromatography): Shimadzu LC6A (manufactured by Shimadzu Corp.)

Column: CLC-ODS (manufactured by Shimadzu Corp.)

Detection wavelength: 290 nm

Mobile phase: methanol/tetrahydrofuran=3/1

Flow rate of mobile phase: 1 ml/min

The identification of each compound was made via NMR determination for each sample which was batched off via the high speed liquid chromatography.

Group of compounds of CTM1

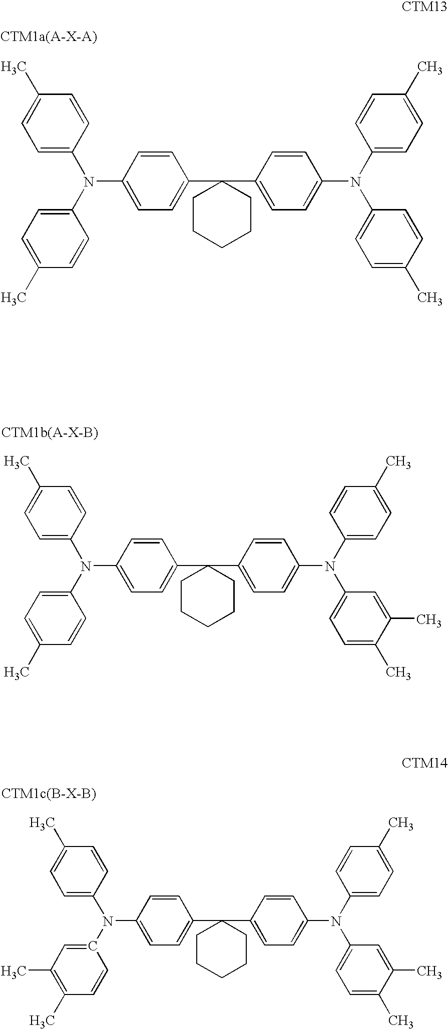

(Synthesis of Compounds of Present Invention: CTM2 to CTM7)

CTM2 to CTM7 were synthesized in a similar manner to the synthesis of CTM1 except that the kinds and amounts (in molar ratio) of amine compounds A and B, and ketone compound were changed to those shown in Table 2.

Each composition ratio of CTM2 to CTM7 was determined in a similar manner to CTM1. The results were given in Table 2.

The composition ratios (percent by mass) of each mixture of bisamine compounds were determined via an area ratio of a high speed liquid chromatography.

TABLE 2

| | Amine compound | | | | Mixture of bisamine | | |
|---|---|---|---|---|---|---|---|
| CTM | | | A/B (molar | Ketone | compounds (% by mass) | | |
| No. | A | B | ratio) | compound | A-X-A | A-X-B | B-X-B |
| 1 | A1 | A2 | 1/1 | K1 | 28 | 43 | 29 |
| 2 | A1 | A3 | 1/1 | K2 | 29 | 48 | 23 |
| 3 | A1 | A4 | 2/1 | K1 | 45 | 42 | 13 |
| 4 | A5 | A2 | 2/1 | K3 | 44 | 30 | 26 |
| 5 | A2 | A6 | 1/1 | K4 | 28 | 56 | 16 |
| 6 | A7 | A1 | 3/1 | K1 | 73 | 23 | 4 |
| 7 | A3 | A8 | 2/1 | K1 | 51 | 43 | 6 |
| 8 | A1 | A2 | 2/1 | K2 | 33 | 35 | 32 |
| 9 | A7 | A1 | 4/1 | K2 | 80 | 12 | 8 |
| 10 | A1 | A6 | 4/1 | K1 | 90 | 6 | 4 |
| 11 | A1 | A4 | 3/1 | K2 | 50 | 46 | 4 |
| 12 | A1 | A6 | 5/1 | K2 | 96 | 3 | 1 |

A and B: sites of substituted amino group structure
X and Y: bivalent linkage groups

(Synthesis of Comparative Compound: CTM13 (CTM1a))

A 200 ml three necked flask equipped with a condenser, a thermometer, and a nitrogen introduction tube was decompressed, and the flask was subjected to a complete nitrogen gas substitution. After that, the flask was charged with 10 g of N,N-bis(p-methylphenyl)aniline, 6.5 g of cyclohexanone, 20 ml of acetic acid, and 0.35 g of methane sulfonic acid, and the resulting solution was stirred at 70° C. under nitrogen gas stream. After 6 hours, the reaction was terminated, a liquid of 300 ml of toluene and 200 ml of water was added into the flask, and then the aqueous phase of the resulting solution was rinsed using a separatory funnel until the aqueous phase was neutralized. The toluene phase was removed, dried with anhydrous magnesium sulfate, and then condensed. The targeted mixture of bisamine compounds was removed via a column chromatography, recrystallized using ethyl acetate, to prepare 6.6 g of CTM13 (CTM1a).

(Synthesis of Comparative Compound: CTM14 (CTM1c))

CTM14 (CTM1c) was prepared in a similar manner to CTM13 except that 10 g of N,N-bis(p-methylphenyl)aniline was changed to 10 g of N-p-methylphenyl-N-3,4-dimethylphenylaniline.

(Synthesis of Comparative Compound: CTM15 (CTM2a))

4.3 g of CTM15 (CTM2a) was prepared in a similar manner to CTM13 except that 6.5 g of cyclohexanone was changed to 7.3 g of methyl isobuthyl ketone.

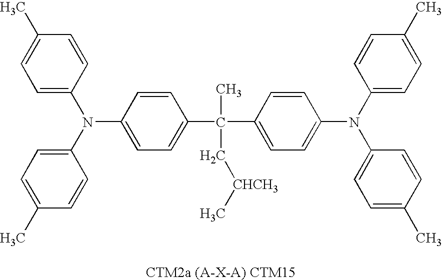

<<Production of Photoreceptor>>

Photoreceptors were produced as described below.

<<Production of Photoreceptor 1>>

(Preparation of Electroconductive Substrate)

As an electroconductive substrate, a rinsed cylindrical aluminum substrate was prepared.

(Formation of Interlayer)

The coating solution described below for an interlayer was applied onto the surface of the above-described cylindrical aluminum substrate by a dip coating method, to form interlayer 1 exhibiting a dried film thickness of 0.3 μm.

Coating Solution for Interlayer

| | |
|---|---|
| Polyamide resin (AMILAN CM-8000: produced by | 60 parts by mass |
| Toray Industries Inc.) | |
| Methanol | 1,600 parts by mass |

(Formation of Charge Generation Layer)

The materials below for a charge generation layer were mixed, and the resulting mixture was dispersed via a sand mill for 10 hours to prepare a coating solution for a charge generation layer. The coating solution thus prepared for a charge generation layer was applied onto the above-described interlayer via a dip coating method to form charge generation layer 1 exhibiting a film thickness of 0.3 μm.

Coating Solution for Charge Generation Layer (CGL)

| | | |
|---|---|---|
| Charge generation material (CGM): polycyclic | 24 | parts by mass |
| quinone compound CGM2-4 | | |
| Polyvinyl butyral resin (ESLEK BL-1: | 12 | parts by mass |
| produced by Sekisui Chemical Co., Ltd.) | | |
| 2-butanone/cyclohexanone = 4/1 (v/v) | 800 | parts by mass |

CGM2-4

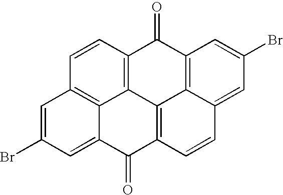

(Formation of Charge Transport Layer)

The materials below for a charge transport layer were mixed, and the resulting mixture was dissolved to prepare a coating solution for a charge transport layer. The coating solution was applied onto charge generation layer 1 via a dip coating method, and then heat-dried at 120° C. for 70 minutes, to form charge transport layer 1 exhibiting a film thickness of 20 μm to result in a production of photoreceptor 1.

Coating Solution for Charge Transport Layer (CTL)

| | | |
|---|---|---|
| Charge transport material (mixture of bisamine | 200 | parts by mass |
| compounds comprising illustrated compound | | |
| CTM-1; CTM-1a/CTM1b/CTM1c = 28/43/29 | | |
| (percent by mass) | | |
| Bis-phenol Z type polycarbonate (IUPILON | 300 | parts by mass |
| Z300: produced by Mitsubishi Gas Chemical | | |
| Co., Inc.) | | |
| Tetrahydrofuran | 1,600 | parts by mass |
| Toluene | 400 | parts by mass |
| Antioxidant (2,6-di-t-butylhydroxytoluen) | 7.5 | parts by mass |
| Silicone oil (KF-96: produced by Shin-Etsu | 0.2 | parts by mass |
| Chemical Co., Ltd.) | | |

<<Production of Photoreceptors 2 to 12>>

Each of photoreceptors 2 to 12 was produced in a similar manner to the production of photoreceptor 1 except that charge transport material CTM-1 was changed to each of CTM2 to CTM12 respectively.

<<Production of Photoreceptors 13 to 15>>

Each of photoreceptors 13 to 15 was produced in a similar manner to the production of photoreceptor 1 except that charge transport material CTM-1 was changed to each of CTM13 to CTM15 respectively.

<<Production of Photoreceptor 16>>

Photoreceptor 16 was produced in a similar manner to the production of photoreceptor 1 except that charge transport material CTM-1 was changed to a mixture of CTM13 and CTM14 (in a ratio of 50/50 by mass).

<<Production of Photoreceptor 17>>

Photoreceptor 17 was produced in a similar manner to the production of photoreceptor 1 except that charge transport material CTM-1 was changed to a mixture of CTM13 and CTM15 (in a ratio of 50/50 by mass). <<Production of Photoreceptor 18>>

Photoreceptor 18 was produced in a similar manner to the production of photoreceptor 1 except that illustrative charge transport material CTM-1 was changed to a mixture of CTM13 and CTM15 (in a ratio of 75/25 by mass).

<<Evaluation of Photoreceptor>>

Each photoreceptor thus produced was evaluated as below.

(State of Coated Film on Photoreceptor)

The state of the coated film of each photoreceptor thus produced was evaluated by visual observation on the surface of the coated film before and after storage test. The storage test was carried out by keeping each photoreceptor at 30° C. and 80% RH for one month, after which the state of the coated film was evaluated.

(Image Characteristics)

As an image forming apparatus for evaluation of image characteristics, an exposure means was prepared employing the copier “bishub PRO C6500” (produced by Konica Minolta Business Technologies Inc.) with the exposure light source being changed to a violet laser exhibiting a laser oscillation wavelength of 408 nm and the exposure dot size being narrowed down from 60 μm to 20 μm.

The four photoreceptors thus produced were mounted one-by-one at positions of Y, M, C, and black in the above image forming apparatus. After that, employing A4 size plain paper (64 g/m²), one hundred thousand prints of a color image were made under an atmosphere of 20° C. and 50% RH. After the evaluation of the actual image, the surface of the photoreceptor was observed to note anything unusual on its surface.

Image evaluation was carried out on image sharpness employing an original image having four equal quarter parts of a character image having a pixel ratio of 7% (characters of 3-point and 5-point), a portrait (a dot image containing a halftone image), a solid white image, and a solid black image, a spot in a halftone image, and fog. Further, the state of the coated film on the surface of the photoreceptor was observed. The image evaluation was carried out employing printed images on A4 size neutral paper (64 g/m²).

(Generation of Spot Defects in Half Tone Image)

Spot defects in a half tone image were evaluated in such a manner that, after printing of one hundred thousand prints, each of photoreceptors 1 to 18 was mounted at the black position, and a half tone image exhibiting image density of 0.4 was printed on one hundred A4 size plain papers under an atmosphere of low temperature and low relative humidity (at 10° C. and 15% RH). The evaluation was carried out to see how many visually observable spots (of at least 0.4 mm), the generation cycle of whose spots agrees with that of the photoreceptor, are present per A4 size sheet.

Evaluation Criteria

A: The generation frequency of a spot is 3 or less per A4 size sheet, which was considered to be “good”.

B: The generation frequency of a spot is 4 to 8 per A4 size sheet, which was considered to be no problem in practice.

C: The generation frequency of a spot is 9 or more per A4 size sheet, which was considered to be a problem in practice.

Criteria A and B were regarded as acceptable, while C was regarded as unacceptable (that is, being a problem).

(Image Fog)

Image fog was evaluated by a density difference between fog density on a print without an image after printing of one hundred thousand and density of a white plain paper (64 g/m²). In the present invention, the fog level was evaluated together with influences of the kinds and amounts of charge transport materials employed for formation of the charge transport layer.

White paper densities of an image receiving material were measured at 20 random locations per A4 size sheet, and the average value thereof was regarded as the white paper density.

Fog densities on a print without an image after one hundred thousand printings were conducted were measured at 20 random locations per A4 size sheet, and the average value thereof was regarded as the fog density. The density measurement was carried out employing a reflection densitometer (RD-918: manufactured by Macbeth Corp.)

Evaluation Criteria

A: Image fog is less than 0.03, which was considered to be “good”.

B: Image fog is 0.003 or more and less than 0.010, which was considered to be a level of no problem in practice.

C: Image fog is 0.010 or more, which was considered to be a level of problem in practice.

Criteria A and B were regarded as acceptable, while C was regarded as unacceptable (that is, being a problem).

(Image Sharpness)

Image sharpness was evaluated by noting any damaged characters in the 3- and 5-point character images, which images were made by printing of an original image (3- and 5-point character images) under an atmosphere of high temperature and normal relative humidity (at 30° C. and 80% RH).

Evaluation Criteria

A: Both 3- and 5-point characters are clear and readily readable.

B: Parts of the 3-point characters are not readable, but the 5-point characters are clear and readily readable.

C: The 3-point characters are almost not readable, and parts or all of the 5-point characters are not readable.

Criteria A and B were regarded as acceptable, while C was regarded as unacceptable (that is, being a problem).

(State of Coated Film on Surface of Photoreceptor)

The state of the coated film on the surface of a photoreceptor was visually observed, which receptor was removed after production of one hundred thousand prints.

The evaluation results are shown in Table 3.

TABLE 3

| | | State of coated film | | | | | | | | |
|---|---|---|---|---|---|---|---|---|---|---|
| | | of photoreceptor | | | | After 100,000 printings | | | | |
| Photo- | Charge | Before | After | Initial | | | | | Surface | |
| receptor | transport | keeping | keeping | Black | | Black | | | of photo- | |
| No. | material | test | test | spot | Fog | spot | Fog | Sharpness | receptor | Note |
| 1 | CTM-1 | Normal | Normal | A | A | A | A | A | Normal | Inv. |
| 2 | CTM-2 | Normal | Normal | A | B | A | B | A | Normal | Inv. |
| 3 | CTM-3 | Normal | Normal | A | A | B | A | A | Normal | Inv. |
| 4 | CTM-4 | Normal | Normal | B | A | B | B | A | Normal | Inv. |
| 5 | CTM-5 | Normal | Normal | A | B | A | A | B | Normal | Inv. |
| 6 | CTM-6 | Normal | Normal | A | B | B | A | B | Normal | Inv. |
| 7 | CTM-7 | Normal | Normal | A | A | A | B | B | Normal | Inv. |
| 8 | CTM-8 | Normal | Normal | A | B | B | B | B | Normal | Inv. |
| 9 | CTM-9 | Normal | Normal | A | B | B | B | B | Normal | Inv. |
| 10 | CTM-10 | Normal | Normal | B | B | B | B | B | Normal | Inv. |
| 11 | CTM-11 | Normal | Normal | A | B | B | B | B | Normal | Inv. |
| 12 | CTM-12 | Normal | Normal | B | B | B | B | B | Normal | Inv. |
| 13 | CTM-13 | Normal | *1 | A | A | C | B | B | Generation | Comp. |
| | | | | | | | | | of cracks | |
| 14 | CTM-14 | *1 | *1 | Not evaluated | | | | | | Comp. |
| 15 | CTM-15 | Normal | Normal | A | B | C | C | C | Normal | Comp. |
| 16 | CTM-13/CTM-14 | Normal | *1 | B | B | C | B | C | Generation | Comp. |
| | (50/50) | | | | | | | | of cracks | |
| 17 | CTM-13/CTM-15 | Normal | Normal | B | B | B | C | C | Toner | Comp. |
| | (50/51) | | | | | | | | filming | |
| 18 | CTM-13/CTM-15 | Normal | *1 | A | B | C | B | B | Generation | Comp. |
| | (75/25) | | | | | | | | of cracks | |

*1: Generation of fine cracks,
Inv.: Present invention,
Comp.: Comparative example

As Table 3 clearly shows, in photoreceptors 1 to 9 of the present invention, which were produced by employing the mixture of bisamine compounds of the present invention as a charge transport material, anything unusual was not observed in the coated film even after a keeping test under conditions of high temperature and high relative humidity. While, among photoreceptors of comparative examples, photoreceptors 13 and 14 in which each composition constituent of CTM-1 was added individually, photoreceptor 16 in which comparative bisamine compounds 13 and 14 were mixed, and photoreceptor 17 in which comparative bisamine compounds 13 and 15 were mixed, showed generation of fine cracks. It can be assumed that the reason for the generation of the fine cracks is that since compatibility to resins is insufficient under conditions of single constituent of CTM-13 or CTM-14, or a mixture of only CTM-13 and CTM-14, or only CTM-13 and CTM-15, the above CTMs are separated out under the above-described keeping conditions, to result in generation of cracks due to the above separation.

Photoreceptors 1 to 9 of the present invention, in which the mixture of bisamine compounds of the present invention was employed as a charge transport material, resulted in good results in the both initial images and images after one hundred thousand printings, and met the objects of the present invention. On the other hand, comparative photoreceptors 13, and 15 to 18 showed spot, generation of fog or damaged characters of character images in images after one hundred thousand printings, and then, did not meet the objects of the present invention. The image evaluation of comparative photoreceptor 14 was not carried out, since it showed fine cracks before the keeping test was conducted.

### DESCRIPTION OF SIGNS

10Y, 10M, 10C and 10Bk: image forming unit
1Y, 1M, 1C and 1Bk: photoreceptor
2Y, 2M, 2C and 2Bk: charging means
3Y, 3M, 3C and 3Bk: exposure means
4Y, 4M, 4C and 4Bk: developing means

What is claimed is:

1. A mixture of bisamine compounds comprising a bisamine compound represented by Formula (1) and a bisamine compound represented by Formula (2):
A-X-A Formula (1)
A-X—B Formula (2)
wherein, A and B represent a different substituted amino group represented by Formula (3), X represents a bivalent linkage group: 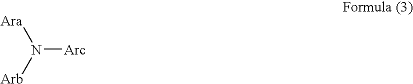
wherein, each of Ara and Arb independently represents an aryl group which may have a substituted group, and Arc represents an arylene group which may have a substituted group, and Ara, Arb and Arc may be combined to form a ring structure.

2. The mixture of bisamine compounds described in claim 1,
wherein the mixture of bisamine compounds further contains a bisamine compound represented by Formula (8):
B—X—B Formula (8)

3. The mixture of bisamine compounds described in claim 1,
wherein the bivalent linking group X is represented by Formula (4): 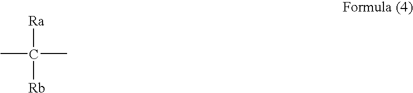
wherein, each of Ra and Rb independently represents a hydrogen atom, an alkyl group which may have a substituent, an allyl group, or a heterocyclic group, and Ra and Rb may be combined to form a ring structure.

4. The mixture of bisamine compounds described in claim 1,
wherein the mixture of bisamine compounds is provided by a reaction of at least two kinds of amine compounds represented by Formula (5) and a ketone compound represented by Formula (6): 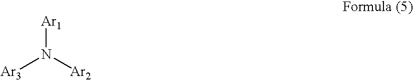
wherein, each of Ar₁ to Ar₃ independently represents an allyl group which may have a substituent, and Ar₁ to Ar₃ may be combined to form a ring structure: 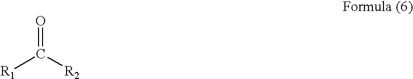
wherein, each of R₁ and R₂ independently represents a hydrogen atom, an alkyl group which may have a substituent, an allyl group, or a heterocyclic group, and R₁ and R₂ may be combined to form a ring structure.

5. The mixture of bisamine compounds described in claim 4,
wherein the mixture of bisamine compounds is provided by a reaction of two kinds of amine compounds represented by Formula (5) and a ketone compound represented by Formula (6).

6. The mixture of bisamine compounds described in claim 1,
wherein the mixture of bisamine compounds contains a bisamine compound represented by Formula (7): 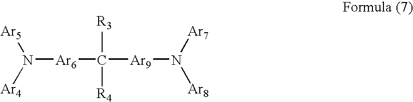
wherein, each of R₃ and R₄ represents a hydrogen atom, an alkyl group or an allyl group, both of which groups may have a substituent, and R₃ and R₄ may be combined to form a ring structure, each of Ar₄, Ar₅, Ar₇, and Ar₈ independently represents an allyl group which may have a substituent, Ar₄ and Ar₅ may be combined to form a ring structure, Ar₇ and Ar₈ may be combined to form a ring structure, each of Ar₆ and Ar₉ independently represents an arylene group which may have a substituent, provided that the substituted amino group represented by (Ar₄, Ar₅, and Ar₆)N— differs from the substituted amino group represented by (Ar₇, Ar₈, and Ar₉)N—.

7. The mixture of bisamine compounds described in claim 1,
wherein X1 and X2 meet Schemes (1) to (3), when each content (in percent by mass) of each bisamine compound in the mixture of bisamine compounds is designated as X1, X2, X3, . . . in descending order:
30≦X1+X2<95 Scheme (1)
20≦X1≦95 Scheme (2)
5≦X2≦45 Scheme (3)

8. An electrophotographic photoreceptor comprising a photosensitive layer incorporating a charge generation material and a charge transport material on a conductive substrate, the above charge transport material is a mixture of bisamine compounds described in claim 1.

9. The electrophotographic photoreceptor described in claim 8,
wherein the charge generation material is a phthalocyanine compound, a perylene compound, a polycyclic quinone compound, or an azo compound.

10. The electrophotographic photoreceptor described in claim 9,
wherein the charge generation material is a polycyclic quinone compound.

11. An image forming apparatus featuring a light exposure means which forms an electrostatic latent image on the electrophotographic photoreceptor employing a writing light source of a semiconductor laser or a light-emitting diode exhibiting an oscillation wavelength of 380 to 500 nm, and a developing means for making the aforesaid electrostatic latent image visible as a toner image,
wherein the electrophotographic photoreceptor is one described in claim 8.

12. A method for forming an image comprising the steps of:
(i) forming an electrostatic latent image on the electrophotographic photoreceptor employing a writing light source of a semiconductor laser or a light-emitting diode exhibiting an oscillation wavelength of 380 to 500 nm as an exposure process, and
(ii) developing the electrostatic latent image to make visible as a toner image as a developing process, wherein the electrophotographic photoreceptor is one described in claim 8.
